(19) United States
(12) Patent Application Publication
(10) Pub. No.: US 2021/0107139 A1
(43) Pub. Date: Apr. 15, 2021

(54) ROBOT USING MACHINE LEARNING

(71) Applicant: HONDA MOTOR CO., LTD., Tokyo (JP)

(72) Inventors: Nawid JAMALI, Dublin, CA (US); Soshi IBA, Mountain View, CA (US)

(21) Appl. No.: 16/600,217

(22) Filed: Oct. 11, 2019

(51) Int. Cl. B25J 9/16; G06N 20/00

(52) U.S. Cl. CPC B25J 9/163; G06N 20/00

(57) ABSTRACT

Aspects of the present disclosure include methods, apparatuses, and computer readable media for performing an undesirable task including receiving an indication identifying a person performing a task at a first time, receiving a plurality of input data associated with the person while performing the task, determining whether the task is undesirable based on the plurality of input data, and causing, in response to determining that the task is undesirable, the robot to perform the task at a second time after the first time.

### TECHNICAL FIELD

The present disclosure relates to a robot using machine learning.

### BACKGROUND

As technology advances, robots are becoming more prevalent in the homes of consumers. Robots may be utilized to clean homes, wash and dry clothes, care for the elderly, and/or offer companionship to the owners. Among the household tasks to be completed, the owners may want to complete certain ones, and leave other tasks to the robots. Therefore, it may be desirable for the robots to complete tasks undesirable by the owners, and leave desirable tasks for the owners to complete.

### SUMMARY

This summary is provided to introduce a selection of concepts in a simplified form that are further described below in the DETAILED DESCRIPTION. This summary is not intended to identify key features of the claimed subject matter, nor is it intended to be used as an aid in determining the scope of the claimed subject matter.

Aspects of the present disclosure include a method for a robot for performing an undesirable task including receiving an indication identifying a person performing a task at a first time, receiving a plurality of input data associated with the person while performing the task, determining whether the task is undesirable based on the plurality of input data, and causing, in response to determining that the task is undesirable, the robot to perform the task at a second time after the first time.

Some aspects of the present disclosure include a robot for performing an undesirable task including a photodetector that receives visual input data of a plurality of input data, a microphone that receive audio input data of the plurality of input data, and a controller having a processor communicatively coupled with a memory having instructions stored therein, wherein the processor executes the instructions to perform the steps of receiving an indication identifying a person performing a task at a first time, receiving a plurality of input data associated with the person while performing the task, determining whether the task is undesirable based on the plurality of input data, and causing, in response to determining that the task is undesirable, the robot to perform the task at a second time after the first time.

One aspect of the present disclosure include a non-transitory computer readable medium having instructions stored therein that, when executed by a processor of a robot, cause the processor to perform the steps of receiving an indication identifying a person performing a task at a first time, receiving a plurality of input data associated with the person while performing the task, determining whether the task is undesirable based on the plurality of input data, and causing, in response to determining that the task is undesirable, the robot to perform the task at a second time after the first time.

### BRIEF DESCRIPTION OF THE DRAWINGS

The novel features believed to be characteristic of aspects of the disclosure are set forth in the appended claims. In the description that follows, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objects and advantages thereof, will be best understood by reference to the following detailed description of illustrative aspects of the disclosure when read in conjunction with the accompanying drawings, wherein:

FIG. 1 illustrates an example of a robot for performing an undesirable task in accordance with aspects of the present disclosure;

FIG. 2 illustrates an example of an environment showing the robot identifying the undesirable task in accordance with aspects of the present disclosure;

FIG. 3 illustrates an example of an environment showing the robot performing the undesirable task in accordance with aspects of the present disclosure;

FIG. 4 illustrates an example of a method of a robot performing an undesirable task in accordance with aspects of the present disclosure;

FIG. 5 illustrates an example of a computer system in accordance with aspects of the present disclosure; and

FIG. 6 illustrates a block diagram of various example system components in accordance with aspects of the present disclosure.

### DETAILED DESCRIPTION

The following includes definitions of selected terms employed herein. The definitions include various examples and/or forms of components that fall within the scope of a term and that may be used for implementation. The examples are not intended to be limiting.

The term “processor,” as used herein, can refer to a device that processes signals and performs general computing and arithmetic functions. Signals processed by the processor can include digital signals, data signals, computer instructions, processor instructions, messages, a bit, a bit stream, or other computing that can be received, transmitted and/or detected. A processor, for example, can include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described herein.

The term “bus,” as used herein, can refer to an interconnected architecture that is operably connected to transfer data between computer components within a singular or multiple systems. The bus can be a memory bus, a memory controller, a peripheral bus, an external bus, a crossbar switch, and/or a local bus, among others. The bus can also be a robot bus that interconnects components inside a robot using protocols such as Controller Area network (CAN), Local Interconnect Network (LIN), among others.

The term “memory,” as used herein, can include volatile memory and/or nonvolatile memory. Non-volatile memory can include, for example, ROM (read only memory), PROM (programmable read only memory), EPROM (erasable PROM) and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM).

The term “operable connection,” as used herein, can include a connection by which entities are “operably connected”, is one in which signals, physical communications, and/or logical communications can be sent and/or received. An operable connection can include a physical interface, a data interface and/or an electrical interface.

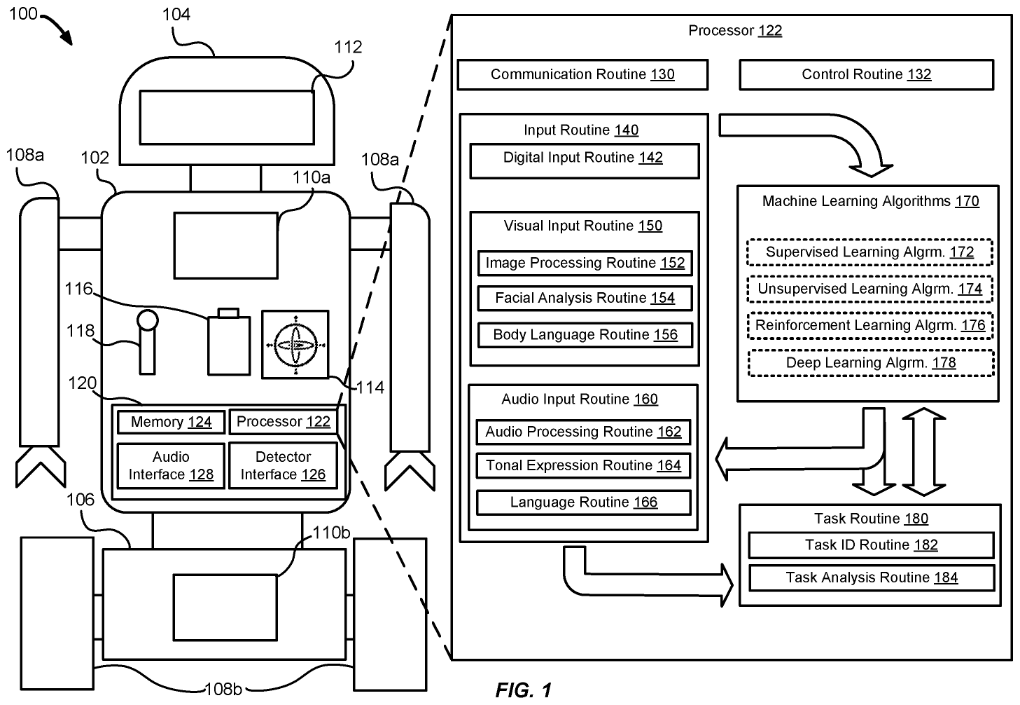

Turning to FIG. 1, in some aspects, a schematic view of a non-limiting example of a robot 100 for performing undesirable tasks may include a body 102. Undesirable tasks may include tasks that are difficult, tedious, boring, scary, tiresome, or troublesome, among other tasks that the person performing the tasks may not wish to undertake. The robot 100 may include a top portion 104 and a bottom portion 106. The robot 100 may include the rotatable top portion 104 having one or more photodetectors 112. The one or more photodetectors 112 may include visible light cameras, infra-red cameras, wide-angle cameras, or other cameras suitable for navigation. The body 102 may include one or more arms 108a moveably coupled to the body 102. The one or more arms 108a may be used to perform the undesirable tasks. The bottom portion 106 may include one or more wheels 108b rotatably coupled to the bottom portion 106. The one or more wheels 108b may provide means for the robot 100 to move from one location to another.

In some instances, the robot 100 may include an arms drive assembly 110a. The arms drive assembly 110a may include gears, wheels, hydraulic systems, electrical systems, mechanical systems, and/or other systems to operate the one or more arms 108a. The robot 100 may include a wheels drive assembly 110b. The wheels drive assembly 110b may include gears, wheels, hydraulic systems, electrical systems, mechanical systems, and/or other systems to operate the one or more wheels 108b.

In some variations, the robot 100 may include one or more gyroscope sensors 114. The one or more gyroscope sensors 114 may detect an orientation of the robot 100. The robot 100 may include a battery 116 that provides electrical energy to other components of the robot 100. The robot 100 may include a microphone 118 for receiving audio input.

In some instances, the robot 100 may include a controller 120 having a processor 122 and a memory 124. The controller 120 may include a detector interface 126 that receives detected signals associated with the images captured by the one or more photodetectors 112. The controller 120 may include an audio interface 128 that receives signals associated with the audio captured by the microphone 118.

In a non-limiting aspect of the present disclosure, the processor 122 may include routines and algorithms for identifying, selecting, and performing the undesirable tasks. The instructions for the routines may be stored in the memory 124 and/or any internal memory (e.g., levels 1, 2, and/or 3 cache memory) of the processor 122. The processor 122 may include a communication component 130 that transmits and/or receives communications signals with external devices via an optional communications device (discussed below). For example, the communication component 130 of the processor 122 may receive commands for the robot 100 from the owner (not shown) of the robot 100 to perform certain tasks via a mobile device (not shown). The communication component 130 of the processor 122 may receive updates from a remote server.

In certain aspects, the processor 122 may include a control routine 132 that issues control signals to the arms drive assembly 110a and/or the wheels drive assembly 110b. The control signals may include instructions for the robot 100 to move to a certain location, perform a certain task, and/or other commands.

In some examples, the processor 122 may include an input routine 140 that receives input data (e.g., training data, observation data, commands). The processor 122 may include a digital input routine 142 receives commands from the mobile device of the owner to perform certain tasks (e.g., via the control routine 132).

In certain examples, the processor 122 may include a visual input routine 150 that includes sub-routines used to analyze visual input (e.g., images and/or videos captured by the one or more photodetectors 112). In one variation, the visual input routine 150 may include an image processing routine 152 that filters, enhances, zooms, rotates, smooths, and/or performs other image processing techniques to the images and/or videos captured by the one or more photodetectors 112). The visual input routine 150 may include a facial analysis routine 154 that analyzes the facial expression of a person (e.g., the owner). The facial analysis routine 154 may determine, based on the analyzed facial expression of the person performing a task, whether the task is desirable or undesirable. The facial analysis routine 154 may perform facial recognition processes to recognize, for example, the owner of the robot 100. The visual input routine 150 may include a body language routine 156 that analyzes the body language of a person (e.g., the robot owner or other person in the household) performing a task to determine whether the task is desirable or undesirable. While the present disclosure refers to an “owner” of the robot, any other individual, either within the household or without, may take the place of the “owner.”

In some aspects of the present disclosure, the input routine 140 may include an audio input routine 160 that includes sub-routines used to analyze audio input (e.g., sounds captured by the microphone 118). In one variation, the audio input routine 160 may include an audio processing routine 162 that filters, enhances, equalizes, delays, advances, accelerates, or performs other audio processing techniques to the sounds captured by the microphone 118. The audio input routine 160 may include a tonal expression routine 164 that analyzes the tonal expression of the sounds verbally produced by a person (e.g., the owner). The tonal expression routine 164 may determine, based on the analyzed tonal expression of the sounds verbally produced by the person performing a task, whether the task is desirable or undesirable. The audio input routine 160 may include a language routine 166 that analyzes the language spoken by a person (e.g., the owner) performing a task to determine whether the task is desirable or undesirable.

In some variations, the processor 122 may include machine learning algorithms 170 that enable the robot 100 to distinguish, for example, a desirable task from an undesirable task based on the input data collected by the robot 100. The machine learning algorithms may include one or more of supervised learning algorithms 172, unsupervised learning algorithms 174, reinforcement learning algorithms 176, and deep learning algorithms 178. The supervised learning algorithms 172 may receive training data as input and desired output. The processor 122 may iteratively execute the supervised learning algorithms 172 until the supervised learning algorithms 172 produces the desired output given the input. The unsupervised learning algorithms 174 may receive a set of input data and search for a common structure. The reinforcement learning algorithms 176 may utilize a decision process, such as a Markov decision process, to determine the action that maximizes reward. For example, the reinforcement learning algorithms 176 may utilize the Markov decision process to recursively perform tasks that maximize reward (e.g., approval provided by the owner). The deep learning algorithms 178 may apply multiple layers of abstractions to progressively extract different features from the input data.

In some instances, the processor 122 may include a task routine 180. The task routine 180 may include a task identification routine 182 that identifies a task being performed by the owner (e.g., mowing the lawn, cleaning dishes, etc.). The task routine 180 may include a task analysis routine 184 that determines, along with the machine learning algorithms 170, an task score to each identified task. The task analysis routine 184 may determine whether each identified task exceeds a predetermined threshold to determine whether the robot 100 should perform the identified task or not.

In optional variations, the robot 100 may include an optional communications device (e.g., wireless modem, not shown) for providing wired or wireless computer communications utilizing various protocols to send/receive electronic signals internally with respect to features and systems within the robot 100 and with respect to external devices. These protocols may include a wireless system utilizing RF communications (e.g., IEEE 802.11 (Wi-Fi), IEEE 802.15.1 (Bluetooth®)), a near field communication system (NFC) (e.g., ISO 13157), a local area network (LAN), a wireless wide area network (WWAN) (e.g., cellular) and/or a point-to-point system. Additionally, the communications device of the robot 100 may be operably connected for internal computer communication via a bus (e.g., a CAN or a LIN protocol bus) to facilitate data input and output between among features and systems.

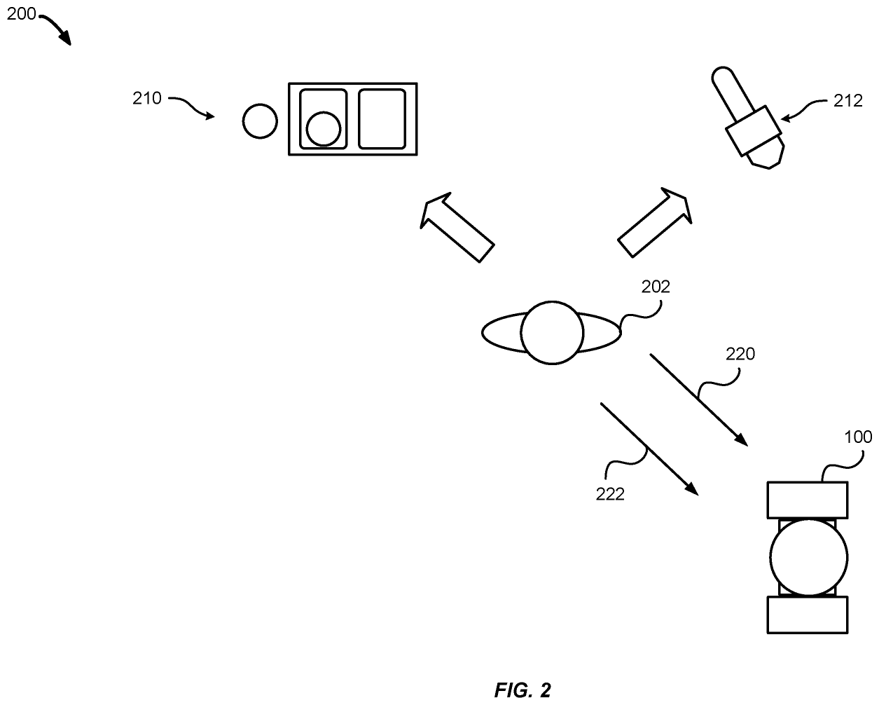

Turning now to FIG. 2, and referencing FIG. 1, in some aspects, therein shown is an example of an environment 200 showing the robot 100 identifying tasks. In some variations, the robot 100 may detect an owner 202 of the robot 100 (and/or other individual) cleaning dishes 210 and painting a house 212. The robot 100 may identify the task via the task ID routine 182. The robot 100 may detect visual input 220 using the one or more photodetectors 112 and/or audio input 222 using the microphone 118. The visual input routine 150 of the processor 122 may receive the visual input 220 via the detector interface 126. The visual input 220 may include images and/or videos of the owner 202 cleaning dishes 210 and painting a house 212. The audio input routine 160 of the processor 122 may receive the audio input 222 via the audio interface 128. The audio input 222 may include verbal or non-verbal sounds from the owner 202 while cleaning dishes 210 and painting a house 212.

In some instances, the image processing routine 152 may enhance the visual input 220. The facial analysis routine 154 may examine the enhanced visual input 220 to identify smiles, frowns, furrowed eyebrows, etc. The body language routine 156 may examine the enhanced visual input 220 to identify the owner 202 (and/or other individual) having a relaxed body posture or clenching his/her fists.

In a non-limiting example, the audio processing routine 162 may enhance the audio input 222. The tonal expression routine 164 may examine the enhanced audio input 222 to identify whistling by the owner 202 (and/or other individual), sighing, etc. The language routine 166 may examine the enhanced audio input 222 to identify lyrics of a song or curse words.

In certain examples, the robot 100 may understand a number of languages, such as English, Spanish, Mandarin, etc. In some instances, the robot 100 may utilize the optional communications device to download more languages spoken by the owner 202.

Still referring to FIG. 2, the machine learning algorithms 170 or one or more of the sub-routines may determine, based on the facial expressions of the owner 202, whether the owner 202 enjoys the tasks of cleaning dishes 210 and painting a house 212. For example, the facial expressions showing smiles may indicate the owner 202 enjoys the task of cleaning dishes 210. The facial expressions showing furrowed eyebrows may indicate the owner 202 does not enjoy the task of painting a house 212.

In certain aspects, the machine learning algorithms 170 or one or more of the sub-routines may determine, based on the body language of the owner 202, whether the owner 202 enjoys the tasks of cleaning dishes 210 and painting a house 212. For example, the body language showing relaxed body may indicate the owner 202 enjoys the task of cleaning dishes 210. The body language showing clenched fists may indicate the owner 202 does not enjoy the task of painting a house 212.

In some examples, the machine learning algorithms 170 or one or more of the sub-routines may determine, based on the tone of the verbal sounds, whether the owner 202 enjoys the tasks of cleaning dishes 210 and painting a house 212. For example, the tonal expression of whistling may indicate the owner 202 enjoys the task of cleaning dishes 210. The tonal expression of sighing may indicate the owner 202 does not enjoy the task of painting a house 212.

In some variations, the machine learning algorithms 170 or one or more of the sub-routines may determine, based on the words used by the owner 202, whether the owner 202 enjoys the tasks of cleaning dishes 210 and painting a house 212. For example, the words from lyrics of a song may indicate the owner 202 enjoys the task of cleaning dishes 210. Curse words may indicate the owner 202 does not enjoy the task of painting a house 212.

In certain aspects of the present disclosure, the task analysis routine 184 may determine, based on the machine learning algorithms 170 and the input data such as the visual input 220 and the audio input 222, that the task of cleaning dishes 210 is a desirable task. The task analysis routine 184 may determine, based on the machine learning algorithms 170 and the input data such as the visual input 220 and the audio input 222, that the task of painting a house 212 is an undesirable task.

In one example, the task analysis routine 184 may assign an undesirable score to each of the tasks of cleaning dishes 210 and painting a house 212. The undesirable score may depend how the machine learning algorithms 170 determines how desirable the tasks of cleaning dishes 210 and painting a house 212 are to the owner 202. For example, the task analysis routine 184 may assign a score of 13 to the task of cleaning dishes 210 and a score of 91 to the task of painting a house 212.

In other examples, the task analysis routine 184 may categorize and/or label the task of cleaning dishes 210 as desirable and the task of painting a house 212 as undesirable.

In certain aspects of the present disclosure, the machine learning algorithms 170 may utilize one or more of the supervised learning algorithms 172, the unsupervised learning algorithms 174, the reinforcement learning algorithms 176, and/or the deep learning algorithms 178 to determine whether a task is desirable or undesirable. For example, the supervised learning algorithms 172 may be trained with training data sets each including a training input object (e.g., a vector) and a desired output value (e.g., a supervisory signal). The supervised learning algorithms 172 may be adjusted so that executing the supervised learning algorithms 172 using the training input object may yield the desired output value. A non-limiting example of a training data set may include the training input object of “detecting singing while performing a task” and a desired output value of “labeling the task as desirable.” Other training data sets are possible.

In some instances, the unsupervised learning algorithms 174 may search for previously unknown patterns in data sets (e.g., singing, dancing, and smiling while performing a task means the task is desirable).

In other variations, the reinforcement learning algorithms 176 may be utilized to determine whether a task is desirable or undesirable. For example, if the robot 100 performs a first task that has not been determined as desirable or undesirable, and the owner 202 provides a positive feedback (e.g., “thank you,” “good job,” etc.), the reinforcement learning algorithms 176 may determine that the first task is desirable and the task analysis routine 184 may assign a low undesirable score to the first task. In another example, if the robot 100 performs a second task previously determined to be undesirable, and the owner 202 provides a corrective feedback (e.g., “I can do that”), the reinforcement learning algorithms 176 may determine that the second task is desirable and the task analysis routine 184 may lower the undesirable score (or categorize/label the second task as desirable). In a third example, if the robot 100 ignores a third task previously determined to be desirable (so the owner 202 may enjoy the third task), and the owner 202 provides a request (e.g., “perform the third task”), the reinforcement learning algorithms 176 may determine that the third task is undesirable and the task analysis routine 184 may increase the undesirable score (or categorize/label the second task as undesirable).

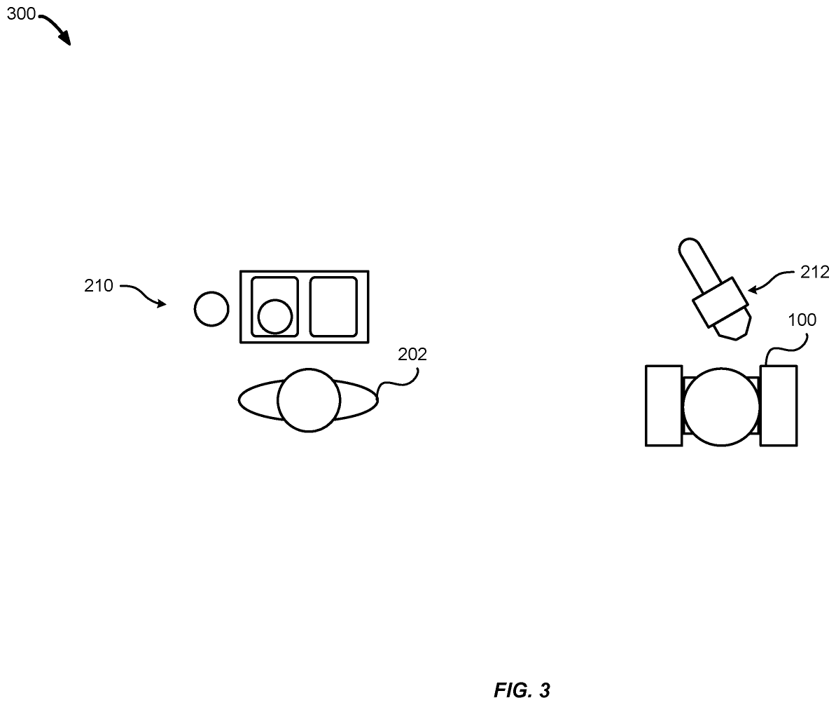

Turning to FIG. 3, in some aspects, therein shown is an example of an environment 300 showing the robot 100 performing undesirable tasks. In some variations, the robot 100 may determine that the tasks of cleaning dishes 210 and painting a house 212 are available. The task analysis routine 184 may determine that, in response to determining the task of cleaning dishes 210 as desirable, the robot 100 will not perform the task of cleaning dishes 210. The task analysis routine 184 may further determine that, in response to determining the task of painting a house 212 as undesirable, the robot 100 will perform the task of painting a house 212.

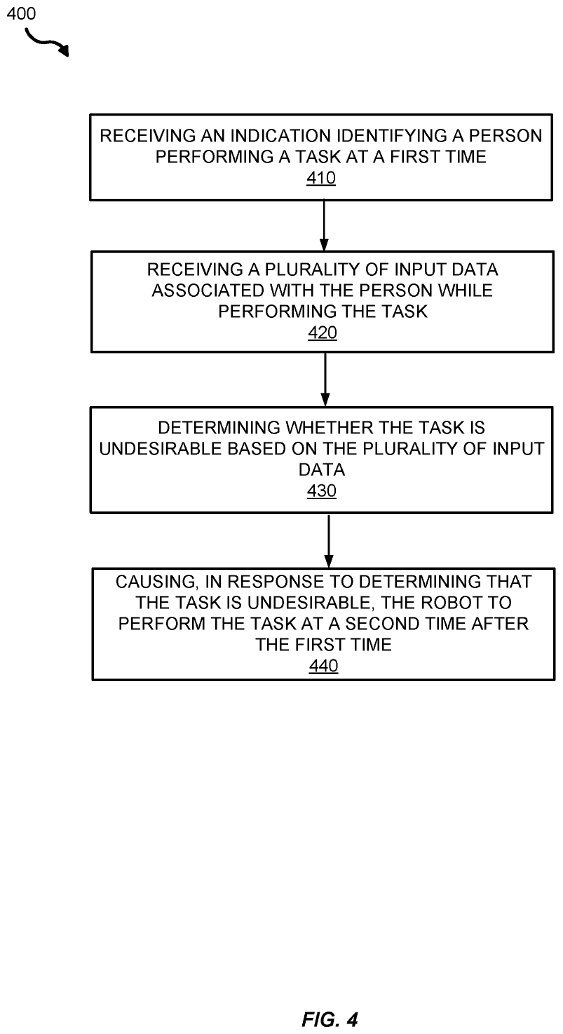

Turning to FIG. 4, an example of a method 400 for performing an undesirable task may be performed by various components including, for example, one or more of the following: the processor 122, the visual input routine 150, the audio input routine 160, the machine learning algorithms 170, and/or the task routine 180 and/or one or more of the sub-routines.

At block 410, the method 400 may receive an indication identifying a person performing a task at a first time. For example, the visual input routine 150 may identify the owner 202 performing the task of painting a house 212.

At block 420, the method 400 may receive a plurality of input data associated with the person while performing the task. For example, the visual input routine 150 and/or the audio input routine 160 of the input routine 140 of the processor 122 may receive the visual input 220 and/or the audio input 222 associated with the owner 202 while performing the task of painting a house 212. The visual input 220 may include facial expressions and/or body languages. The audio input 222 may include tonal expressions and/or verbal languages.

At block 430, the method 400 may determine whether the task is undesirable based on the plurality of input data. For example, the machine learning algorithms 170, the supervised learning algorithms 172, the unsupervised learning algorithms 174, the reinforcement learning algorithms 176, and/or the deep learning algorithms 178 may examine the visual input 220 and/or the audio input 222 to determine whether the task of painting a house 212 is undesirable.

At block 440, the method 400 may cause, in response to determining that the task is undesirable, the robot to perform the task at a second time after the first time. For example, control routine 132 may transmit a plurality of control signals to the arms drive assembly 110a and/or the wheels drive assembly 110b to cause the robot 100 to perform the task of painting a house 212.

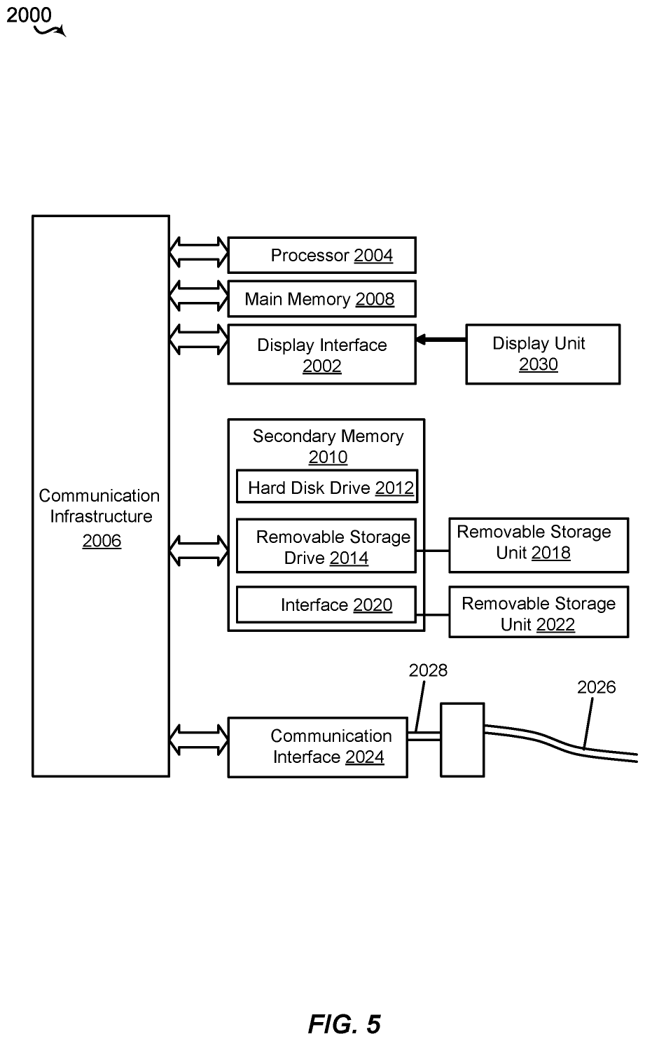

Aspects of the present disclosures may be implemented using hardware, software, or a combination thereof and may be implemented in one or more computer systems or other processing systems. In an aspect of the present disclosures, features are directed toward one or more computer systems capable of carrying out the functionality described herein. For example, the controller 120 may be implemented as the computer system 2000. An example of such the computer system 2000 is shown in FIG. 5.

The computer system 2000 includes one or more processors, such as processor 2004. The processor 2004 is connected to a communication infrastructure 2006 (e.g., a communications bus, cross-over bar, or network). Various software aspects are described in terms of this example computer system. After reading this description, it will become apparent to a person skilled in the relevant art(s) how to implement aspects of the disclosures using other computer systems and/or architectures.

The computer system 2000 may include a display interface 2002 that forwards graphics, text, and other data from the communication infrastructure 2006 (or from a frame buffer not shown) for display on a display unit 2030. Computer system 2000 also includes a main memory 2008, preferably random access memory (RAM), and may also include a secondary memory 2010. The secondary memory 2010 may include, for example, a hard disk drive 2012, and/or a removable storage drive 2014, representing a floppy disk drive, a magnetic tape drive, an optical disk drive, a universal serial bus (USB) flash drive, etc. The removable storage drive 2014 reads from and/or writes to a removable storage unit 2018 in a well-known manner. Removable storage unit 2018 represents a floppy disk, magnetic tape, optical disk, USB flash drive etc., which is read by and written to removable storage drive 2014. As will be appreciated, the removable storage unit 2018 includes a computer usable storage medium having stored therein computer software and/or data.

Alternative aspects of the present disclosures may include secondary memory 2010 and may include other similar devices for allowing computer programs or other instructions to be loaded into computer system 2000. Such devices may include, for example, a removable storage unit 2022 and an interface 2020. Examples of such may include a program cartridge and cartridge interface (such as that found in video game devices), a removable memory chip (such as an erasable programmable read only memory (EPROM), or programmable read only memory (PROM)) and associated socket, and the removable storage unit 2022 and interface 2020, which allow software and data to be transferred from the removable storage unit 2022 to computer system 2000.

Computer system 2000 may also include a communications interface 2024. Communications interface 2024 allows software and data to be transferred between computer system 2000 and external devices. Examples of communications interface 2024 may include a modem, a network interface (such as an Ethernet card), a communications port, a Personal Computer Memory Card International Association (PCMCIA) slot and card, etc. Software and data transferred via communications interface 2024 are in the form of signals 2028, which may be electronic, electromagnetic, optical or other signals capable of being received by communications interface 2024. These signals 2028 are provided to communications interface 2024 via a communications path (e.g., channel) 2026. This path 2026 carries signals 2028 and may be implemented using wire or cable, fiber optics, a telephone line, a cellular link, an RF link and/or other communications channels. In this document, the terms “computer program medium” and “computer usable medium” are used to refer generally to media such as a removable storage unit 2018, a hard disk installed in hard disk drive 2012, and signals 2028. These computer program products provide software to the computer system 2000. Aspects of the present disclosures are directed to such computer program products.

Computer programs (also referred to as computer control logic) are stored in main memory 2008 and/or secondary memory 2010. Computer programs may also be received via communications interface 2024. Such computer programs, when executed, enable the computer system 2000 to perform the features in accordance with aspects of the present disclosures, as discussed herein. In particular, the computer programs, when executed, enable the processor 2004 to perform the features in accordance with aspects of the present disclosures. Accordingly, such computer programs represent controllers of the computer system 2000.

In an aspect of the present disclosures where the method is implemented using software, the software may be stored in a computer program product and loaded into computer system 2000 using removable storage drive 2014, hard disk drive 2012, or the interface 2020. The control logic (software), when executed by the processor 2004, causes the processor 2004 to perform the functions described herein. In another aspect of the present disclosures, the system is implemented primarily in hardware using, for example, hardware components, such as application specific integrated circuits (ASICs). Implementation of the hardware state machine so as to perform the functions described herein will be apparent to persons skilled in the relevant art(s).

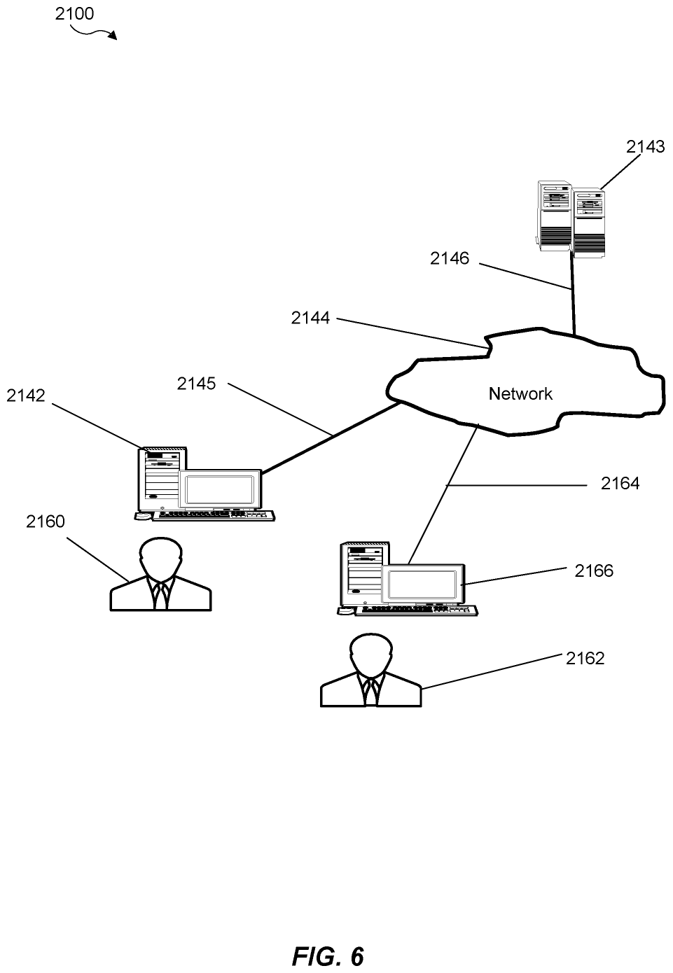

FIG. 6 is a block diagram of various example system components, in accordance with an aspect of the present disclosure. FIG. 6 shows a communication system 2100 usable in accordance with the present disclosure. The communication system 2100 includes one or more accessors 2160, 2162 (also referred to interchangeably herein as one or more “users”) and one or more terminals 2142, 2166. In one aspect, data for use in accordance with aspects of the present disclosure is, for example, input and/or accessed by the one or more accessors 2160, 2162 via the one or more terminals 2142, 2166, such as personal computers (PCs), minicomputers, mainframe computers, microcomputers, telephonic devices, or wireless devices, such as personal digital assistants (“PDAs”) or a hand-held wireless devices coupled to a server 2143, such as a PC, minicomputer, mainframe computer, microcomputer, or other device having a processor and a repository for data and/or connection to a repository for data, via, for example, a network 2144, such as the Internet or an intranet, and couplings 2145, 2146, 2164. The couplings 2145, 2146, 2164 include, for example, wired, wireless, or fiberoptic links. In another example variation, the method and system in accordance with aspects of the present disclosure operate in a stand-alone environment, such as on a single terminal.

It will be appreciated that various implementations of the above-disclosed and other features and functions, or alternatives or varieties thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. A method of a robot using machine learning, comprising:
receiving an indication identifying a person performing a task at a first time;
receiving a plurality of input data associated with the person while performing the task;
determining whether the task is undesirable based on the plurality of input data; and
causing, in response to determining that the task is undesirable, the robot to perform the task at a second time after the first time.

2. The method of claim 1, wherein the plurality of input data comprises at least one of visual input data and audio data.

3. The method of claim 2, wherein the visual input data comprises at least one of a facial expression of the person and a body language of the person.

4. The method of claim 2, further comprising, performing image processing techniques to the visual input data.

5. The method of claim 2, wherein the audio input data comprises at least one of a tonal expression of the person or a word spoken by the person.

6. The method of claim 2, further comprising performing audio processing techniques to the audio input data.

7. The method of claim 1, wherein determining whether the task is undesirable comprises applying machine learning algorithms to the plurality of input data.

8. The method of claim 7, wherein the machine learning algorithms comprises at least one of supervised learning algorithms, unsupervised learning algorithms, reinforcement learning algorithms, and deep learning algorithms.

9. A robot comprising:
a photodetector that receives visual input data of a plurality of input data;
a microphone that receive audio input data of the plurality of input data; and
a controller having a processor communicatively coupled with a memory having instructions stored therein, wherein the processor executes the instructions to perform the steps of:
receiving an indication identifying a person performing a task at a first time;
receiving the plurality of input data associated with the person while performing the task;
determining whether the task is undesirable based on the plurality of input data; and
causing, in response to determining that the task is undesirable, the robot to perform the task at a second time after the first time.

10. The robot of claim 9, further comprising a battery that supplies electrical energy to the robot.

11. The robot of claim 9, further comprising:
one or more arms; and
an arms drive assembly that controls the one or more arms.

12. The robot of claim 9, further comprising:
one or more wheels; and
a wheels drive assembly that rotate the one or more wheels to move the robot.

13. The robot of claim 9, wherein the visual input data comprises at least one of a facial expression of the person and a body language of the person.

14. The robot of claim 9, further comprising, performing image processing techniques to the visual input data.

15. The robot of claim 9, wherein the audio input data comprises at least one of a tonal expression of the person or a word spoken by the person.

16. The robot of claim 9, further comprising performing audio processing techniques to the audio input data.

17. The robot of claim 9, wherein the instructions for determining whether the task is undesirable comprises instructions that, when executed by the processor, cause the processor to perform the step of applying machine learning algorithms to the plurality of input data.

18. The robot of claim 17, wherein the machine learning algorithms comprises at least one of supervised learning algorithms, unsupervised learning algorithms, reinforcement learning algorithms, and deep learning algorithms.

19. A non-transitory computer readable medium having instructions stored therein that, when executed by a processor of a robot, cause the processor to perform the steps of:
receiving an indication identifying a person performing a task at a first time;
receiving a plurality of input data associated with the person while performing the task;
determining whether the task is undesirable based on the plurality of input data; and
causing, in response to determining that the task is undesirable, the robot to perform the task at a second time after the first time.

20. The non-transitory computer readable medium of claim 19, wherein:
the plurality of input data comprises at least one of visual input data and audio data;
the visual input data comprises at least one of a facial expression of the person and a body language of the person; and
the audio input data comprises at least one of a tonal expression of the person or a word spoken by the person.
